(19) United States
(12) Patent Application Publication
(10) Pub. No.: US 2025/0080705 A1
(43) Pub. Date: Mar. 6, 2025

(54) PROJECTION DEVICE

(71) Applicant: Coretronic Corporation, Hsin-Chu (TW)

(72) Inventors: Kun-Zheng Lin, Hsin-Chu (TW); Wen-Chun Wang, Hsin-Chu (TW); Wei-Ting Wu, Hsin-Chu (TW); Wen-Chieh Chung, Hsin-Chu (TW); Jui-Chi Chen, Hsin-Chu (TW)

(73) Assignee: Coretronic Corporation, Hsin-Chu (TW)

(21) Appl. No.: 18/811,802

(22) Filed: Aug. 22, 2024

(30) Foreign Application Priority Data
Aug. 29, 2023 (CN) 202311092929.7

(51) Int. Cl. H04N 9/31

(52) U.S. Cl. CPC H04N 9/317; H04N 9/3167

(57) ABSTRACT

A projection device includes a light source module, a display panel, a freeform-surface reflective mirror, and a projection lens. The light source module includes a light source, a first Fresnel lens element, and a second Fresnel lens element. The first Fresnel lens element and the second Fresnel lens element are parallel to each other and located between the light source and the display panel. The display panel is arranged between the light source module and the freeform-surface reflective mirror. The projection lens is configured to transmit an image beam out of the projection device, and a direction of an optical axis of the projection lens is different from a direction of a normal of the first Fresnel lens element.

### CROSS-REFERENCE TO RELATED APPLICATION

This application claims the priority benefit of China application serial no. 202311092929.7 filed on August 29. 2023. The entirety of the above-mentioned patent application is hereby incorporated by reference herein and made a part of this specification.

### BACKGROUND

### Technical Field

The disclosure relates to an imaging system, and more particularly, to a projection device.

### Related Art

In the structure of a conventional projector, after a light source emits a light, the beam angle of the light is converged by a condensing element and then converged by a Fresnel lens element into a parallel light beam. The parallel light beam illuminates a non-self-luminous display panel (e.g., a liquid crystal panel) for image modulation to generate an image beam. After exiting the display panel, the image beam is collected into a projection lens module by a second Fresnel lens element (also commonly known as a field lens) and projected to a screen.

However, although the Fresnel lens element has advantages of a small volume and a low cost, the structure of the Fresnel lens element in actual products has ineffective regions that do not have a refractive effect and reduce the imaging quality (e.g., discontinuous surfaces on the refractive surface of the Fresnel lens element), and unavoidable defects in the manufacturing process (e.g., the portion between the refractive surface and the discontinuous surface of the Fresnel lens element should theoretically be a sharp corner, but is formed as a rounded corner with a radius of curvature in the plastic injection molding process). The above structures both further sacrifice the imaging quality. On the other hand, in the conventional art, if an offset image is generated by tilting the projection lens, the optical axis of the Fresnel lens element would be tilted, such that more of the image beam passes through the ineffective regions and rounded corners, which further distorts the image and reduces the resolution. To reduce the ineffective regions and the radius of curvature of the rounded corners, the production cost of the components inevitable increases, which reduces the product competitiveness. Thus, the above problems still need to be solved by manufacturers in the industry.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure were acknowledged by a person of ordinary skill in the art.

### SUMMARY

According to an embodiment of the disclosure, a projection device is provided, and the projection device includes a light source module, a display panel, a freeform-surface reflective mirror, and a projection lens. The light source module is configured to provide an illumination beam and includes a light source, a first Fresnel lens element, and a second Fresnel lens element. The first Fresnel lens element and the second Fresnel lens element respectively have a first light incident surface and a second light incident surface. A normal of the first light incident surface is parallel to a normal of the second light incident surface. The first Fresnel lens element is arranged between the light source and the second Fresnel lens element. The display panel is configured to convert the illumination beam into an image beam. The first Fresnel lens element and the second Fresnel lens element are arranged between the light source and the display panel. The freeform-surface reflective mirror is arranged on a path of the image beam. The display panel is arranged between the light source module and the freeform-surface reflective mirror. The projection lens is configured to transmit the image beam from the freeform-surface reflective mirror out of the projection device. The projection lens includes a lens optical axis, and a direction of the lens optical axis is different from a direction of the normal of the first light incident surface.

To make the above features and advantages of the disclosure clearer and easier to understand, embodiments will be specifically provided below and described in detain with reference to the accompanying drawings.

Other objectives, features and advantages of the disclosure will be further understood from the further technological features disclosed by the embodiments of the disclosure wherein there are shown and described preferred embodiments of the disclosure, simply by way of illustration of modes best suited to carry out the disclosure.

### BRIEF DESCRIPTION OF DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a projection device according to an embodiment of the disclosure.

FIG. 2 is a schematic view of the structure of the projection device of the embodiment in FIG. 1.

FIG. 3 is a schematic view of the structure of a projection device according to another embodiment of the disclosure.

FIG. 4 is an irradiance distribution diagram of a projection device according to an embodiment of the disclosure.

### DESCRIPTION OF EMBODIMENTS

In the following detailed description of the exemplary embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The projection device provided according to the embodiments of the disclosure can reduce distortion in a projection image or mitigate a decrease in the resolution at the edge of the projection image.

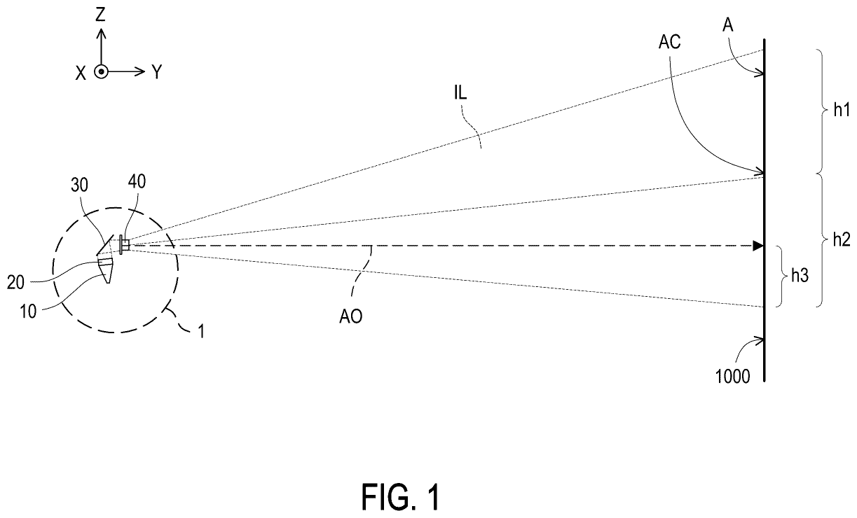

FIG. 1 is a schematic view of a projection device according to an embodiment of the disclosure. Referring to FIG. 1 first, according to an embodiment of the disclosure, a projection device 1 is provided, and the projection device 1 includes a light source module 10, a display panel 20, a freeform-surface reflective mirror 30, and a projection lens 40. The display panel 20 is arranged between the light source module 10 and the freeform-surface reflective mirror 30. The freeform-surface reflective mirror 30 is arranged on the optical path of an image beam IL from the display panel 20. The image beam IL is transmitted to the projection lens 40 by reflection of the freeform-surface reflective mirror 30, and is transmitted out of the projection device 1 after passing through the projection lens 40.

The projection lens 40 of the projection device 1 has a lens optical axis AO. The image beam IL emitted by the projection device 1 of this embodiment forms an image beam region A on a projection surface 1000 (e.g., a projection screen or a projection wall) perpendicular to the lens optical axis AO, and the lens optical axis AO may be configured not to pass through an image beam region center AC of the image beam region A. For example, the image beam IL is transmitted in a direction Y, and the formed image beam region A may form a rectangular projection image on the projection surface 1000 (i.e., a plane composed of a direction X and a direction Z in FIG. 1, the lens optical axis AO is parallel to the direction Y). The image beam region center AC of the image beam region A is, for example, the center of the rectangular projection image. In the direction Z, the image beam region center AC is apart from the upper and lower boundaries of the image beam region A by the same distance, i.e., a first height h1 and a second height h2, and the first height h1 is equal to the second height h2. The position of the lens optical axis AO on the image beam region A is apart from the lower boundary of the image beam region A by a third height h3, and the third height h3 is less than the second height h2. In other words, the projection device 1 may be an offset image projector. Thus, when the projection device 1 is used, the projection device 1 may be simply placed on a flat surface (e.g., a table surface) without being elevated with a stand or an angle adjustment element, and the image beam region A (projection image) can be presented on a surface for users to view. As an example, in the illustration in FIG. 1, the offset effect of the image beam region A is 80%, but the disclosure is not limited thereto. In other embodiments, the offset effect of the projection device 1 may be between 50% and 100%.

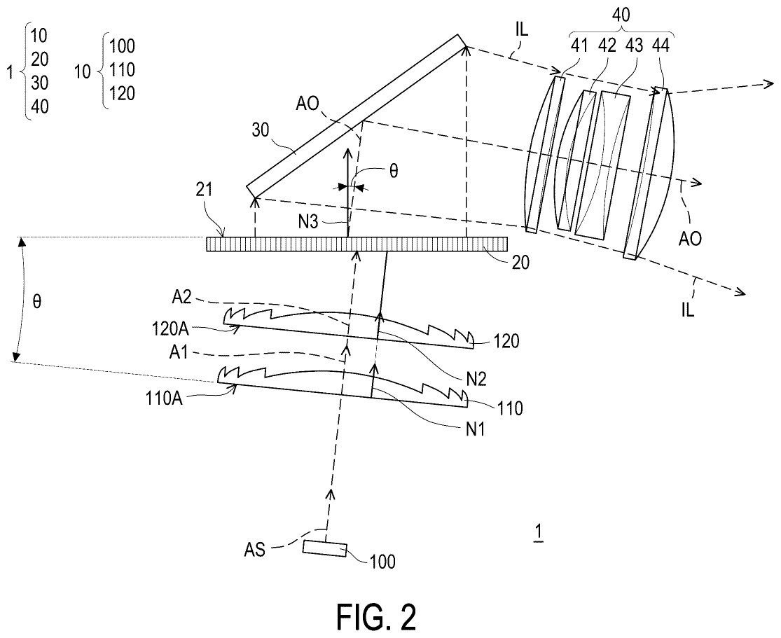

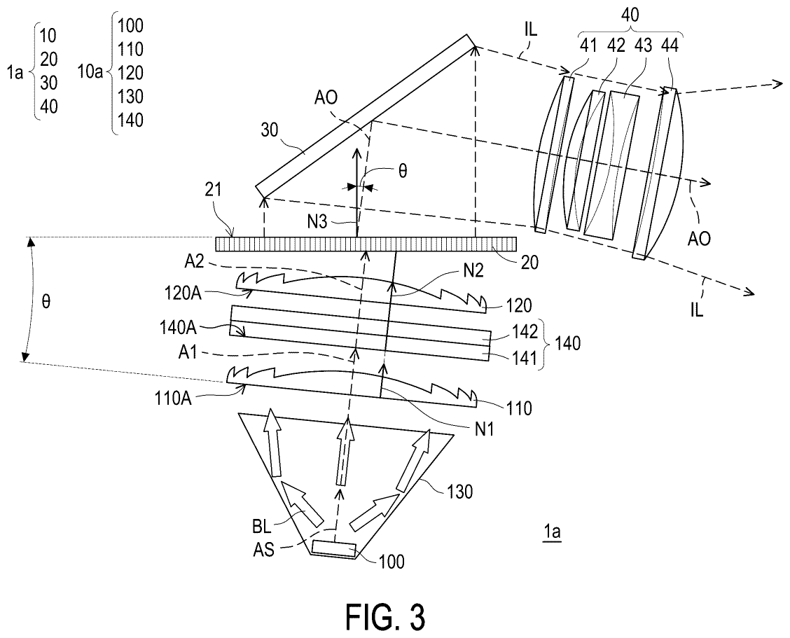

FIG. 2 is a schematic view of the structure of the projection device in FIG. 1. Referring to FIG. 2, the light source module 10 includes a light source 100 configured to provide an illumination beam BL (as shown in FIG. 3), a first Fresnel lens element 110, and a second Fresnel lens element 120. The first Fresnel lens element 110 and the second Fresnel lens element 120 respectively have a first light incident surface 110A and a second light incident surface 120A. The first Fresnel lens element 110 and the second Fresnel lens element 120 may each be a single linear Fresnel lens element or a single circular Fresnel lens element, and correspondingly include a refractive surface with a refractive power configured in concentric circles or configured linearly. The first light incident surface 110A and the second light incident surface 120A may be planar surfaces without a refractive power, and may be arranged on the opposite side of the refractive surface described above. A normal N1 of the first light incident surface 110A may be parallel to a normal N2 of the second light incident surface 120A. In other words, the first Fresnel lens element 110 and the second Fresnel lens element 120 may be arranged parallel to each other, such that the illumination beam BL can be easily converged by the first Fresnel lens element 110 and the second Fresnel lens element 120, and stray light generated by unexpected refraction or reflection can be reduced. On the other hand, the first Fresnel lens element 110 is arranged between the light source 100 and the second Fresnel lens element 120.

In an exemplary embodiment, to reduce heat generated by the projection device 1, the light source 100 may be a light-emitting diode (LED). The first Fresnel lens element 110 and the second Fresnel lens element 120 may be, for example, plastic lens elements or optical glass lens elements. Since the first Fresnel lens element 110 and the second Fresnel lens element 120 are low-cost, thin, and involve mature technology, adopting the first Fresnel lens element 110 and the second Fresnel lens element 120 to converge the illumination beam BL contributes to reductions in the weight, size, and cost of the projection device 1. In contrast, in the case of converging light with dual lens element arrays arranged in parallel, as the cost is generally high and the yield of the micro-lens element structure in the lens element array is difficult to maintain, it is difficult to popularize projection devices that adopt lens element arrays to converge light. In this embodiment, the first Fresnel lens element 110 and the second Fresnel lens element 120 are adopted, which may contribute to reducing the cost of the projection device 1 and enhancing product competitiveness.

The display panel 20 is configured to convert the illumination beam BL into an image beam IL. For example, the display panel 20 may be a liquid crystal display (LCD), and the projection device 1 may be a single-panel LCD projector. In this embodiment, since the first Fresnel lens element 110 and the second Fresnel lens element 120 are arranged between the light source 100 and the display panel 20, it is not required to further arrange a Fresnel lens element on the light exit side (e.g., a display surface 21) of the display panel 20. That is, the projection device 1 may be a non-telecentric system. In some embodiments, after exiting the display panel 20, the image beam IL may be directly irradiated (transmitted) to the freeform-surface reflective mirror 30. That is, it is possible that no optical element is arranged between the display panel 20 and the freeform-surface reflective mirror 30, which is beneficial to the mechanical design and optical path design of the projection device 1.

In addition, the freeform-surface reflective mirror 30 is arranged on the optical path of the image beam IL and reflects the image beam IL generated by the display panel 20 to the projection lens 40. The freeform-surface reflective mirror 30 of the disclosure is an asymmetric optical element with a freeform reflective surface, which can optimize the image quality of the projection image projected by the projection device 1 and reduce optical aberrations (to be described later) including field curvature and distortion aberration at the edge of the image beam region A.

The projection lens 40 is configured to transmit the image beam IL from the freeform-surface reflective mirror 30 out of the projection device 1, and the direction of the lens optical axis AO (the portion turned by the freeform-surface reflective mirror 30, as shown in FIG. 2) of the projection lens 40 is different from the direction of a normal N3 of the display surface 21 to thereby achieve the offset effect of the projection image. The projection lens 40 sequentially includes, from the object side to the image side, a first lens element 41, a second lens element 42, a third lens element 43, and a fourth lens element 44, which are symmetrically arranged along the lens optical axis AO. The materials of the first lens element 41, the second lens element 42, the third lens element 43, and the fourth lens element 44 may be plastic or glass material, but the disclosure is not limited thereto. In some embodiments, the second lens element 42 and the third lens element 43 may be made of materials with different refractive powers to form a cemented lens element. By cementing two lens elements with different refractive powers, it is possible to effectively eliminate chromatic aberration, but the disclosure is not limited thereto.

In the projection device 1 of this embodiment, since it is not required to arrange a Fresnel lens element on the light exit side of the display panel 20 (e.g., the side of the display surface 21), after the image beam IL exits the display panel 20, the image beam IL is sequentially reflected by the freeform-surface reflective mirror 30, collected by the projection lens 40, and transmitted out of the projection device 1, and throughout this process, it is possible to avoid an influence on the imaging quality of the image beam IL caused by a Fresnel lens element. Accordingly, the projection device 1 can produce a high-resolution projection picture.

In some embodiments, the first Fresnel lens element 110 and the second Fresnel lens element 120 may respectively have a first optical axis A1 and a second optical axis A2, and the first Fresnel lens element 110 and the second Fresnel lens element 120 may be symmetrically configured with respect to the first optical axis A1 and the second optical axis A2, respectively. Furthermore, the first optical axis A1 and the second optical axis A2 may overlap with each other, such that the illumination beam BL can be effectively sequentially converged by the first Fresnel lens element 110 and the second Fresnel lens element 120, and the image beam IL can enter the projection lens 40, which thereby stray light can be reduced. In some embodiments, an optical axis AS of the light source 100 may also be configured to further overlap with the first optical axis A1 and the second optical axis A2. In other words, the optical axis AS of the light source 100, the first optical axis Al of the first Fresnel lens element 110, and the second optical axis A2 of the second Fresnel lens element 120 may all be coaxially arranged, which contributes to integration of the light form of the illumination beam BL to achieve desired optical effect.

In some embodiments, to avoid unnecessary divergence of the illumination beam BL, the refractive power of the first Fresnel lens element 110 may be greater than the refractive power of the second Fresnel lens element 120. For example, the effective focal length of the first Fresnel lens element 110 may be less than the effective focal length of the second Fresnel lens element 120, which can further reduce the divergence angle of the illumination beam BL.

In some embodiments, an angle θ may be present between the display surface 21 of the display panel 20 and the first light incident surface 110A (or the second light incident surface 120A), and the angle θ is greater than or equal to 2 degrees and less than or equal to 10 degrees.

Specifically, the first optical axis A1 of the first Fresnel lens element 110 may form an angle θ with respect to the normal N3 of the display surface 21 of the display panel 20. From another perspective, the illumination beam BL emitted by the light source module 10 may be irradiated to the light incident side of the display panel 20 at an incident angle of θ to thereby correct the angle of the light entering the lens end and achieve better optical geometric efficiency. In this manner, without arranging the display panel 20 in an offset configuration (that is, the turned lens optical axis AO passes through the geometric center of the display surface 21 of the display panel 20), the projection device 1 can produce an offset image effect as shown in FIG. 1 described above. Moreover, since the image beam IL can be effectively collected by the projection lens 40 without excessive brightness loss, it also contributes to maintaining the clarity and high image quality of the display image generated with the image beam IL.

To mitigate the reduction in resolution of the offset image due to trapezoidal distortion, barrel distortion, pincushion distortion, etc., the freeform-surface reflective mirror 30 may be used to correct the image and maintain the image quality. That is, when an image projected to the projection surface 1000 is generated by the projection device 1 of this embodiment, the distortion in the projection picture caused by the tilt of the display panel 20 with respect to the light source module 10 will be compensated by the adjustment to the image beam IL by the freeform-surface reflective mirror 30. With the above configuration, it is possible to avoid adding redundant optical elements in the casing of the projection device 1, such that assembly is simplified, and the volume and weight of the projection device 1 are reduced, while a good image is still provided.

FIG. 3 shows another embodiment of the disclosure. The difference from the projection device 1 in the embodiment of FIG. 2 lies in that, considering improvement in light energy utilization and enhancement in display picture brightness, a light source module 10a of a projection device 1a may further include a condensing element 130 arranged between the first Fresnel lens element 110 and the light source 100. The condensing element 130 may be one of an optical funnel, a condensing bowl, and a lens element, and the disclosure is not limited thereto. The condensing element 130 is capable of concentrating the divergent illumination beam BL emitted by the light source 100, which contributes to increasing the light intensity irradiated to the display panel 20 and further increasing the brightness of the generated image beam IL. A heat dissipation element (e.g., a fin) and a fan (both not shown) may be arranged near the light source 100 or the condensing element 130 to transfer the heat generated by the light source 100 or the condensing element 130 to outside the projection device 1 to avoid an influence on the service life of elements such as the light source 100, the display panel 20, or a circuit board (not shown) therein caused by the thermal energy.

In some embodiments, orthogonal projection areas of the first Fresnel lens element 110 and the second Fresnel lens element 120 onto the display panel 20 may be the same as each other. Since the first Fresnel lens element 110 and the second Fresnel lens element 120 are arranged in parallel, it can also be understood that the areas of the first Fresnel lens element 110 and the second Fresnel lens element 120 are substantially equal to each other. That is, the first Fresnel lens element 110 and the second Fresnel lens element 120 have equivalent lens element areas, but the disclosure is not limited thereto.

On the other hand, the light source module 10a may further include a polarizing element 140. The polarizing element 140 is further arranged between the first Fresnel lens element 110 and the second Fresnel lens element 120. The polarizing element 140 may be parallel to the second Fresnel lens element 120. In other embodiments, the polarizing element 140 may be arranged between the second Fresnel lens element 120 and the display panel 20.

Specifically, the polarizing element 140 may be a linear polarizer. Thus, after passing through the polarizing element 140, the illumination beam BL turns into a linearly polarized light and is transmitted to the display panel 20 for a display medium (e.g., liquid crystal) and an electrode layer in the display panel 20 to modulate and generate the image beam IL. In addition, an angle θ is present between the polarizing element 140 and the display panel 20. That is, in this embodiment, the polarizing element 140 is not arranged inside the display panel 20 as in the case of conventional liquid crystal displays, but is arranged separately from the display panel 20. Accordingly, since the polarizing element 140 is capable of providing a linearly polarized beam, it is not required to further arrange a linear polarizer on the light incident side in the display panel 20, but only one linear polarizer arranged on the display surface 21 would be sufficient.

In some embodiments, the polarizing element 140 may further include a reflective polarizer 141 and a linear polarizer 142. The reflective polarizer 141 may allow light having a specific polarization state to pass through and reflect light not having the specific polarization state back toward the light source 100. The linear polarizer 142 may allow light having a specific polarization state to pass through and absorb light having other polarization state. With the above combination, the reflective polarizer 141 may reflect the light not having the specific polarization state back to the first Fresnel lens element 110, such that more light can be reused by the light source module 10a (e.g., the light source 100 and/or the condensing element 130) and then pass through the reflective polarizer 141 and the linear polarizer 142 to recover more light energy to provide to the display panel 20 and thereby enhance the brightness of the display picture. In other embodiments, the light source module 10a may further include a quarter-wave plate (not shown in the figure) arranged on one side of the second Fresnel lens element 120 that is away from the polarizing element 140, that is, arranged on the second light incident surface 120A of the second Fresnel lens element 120.

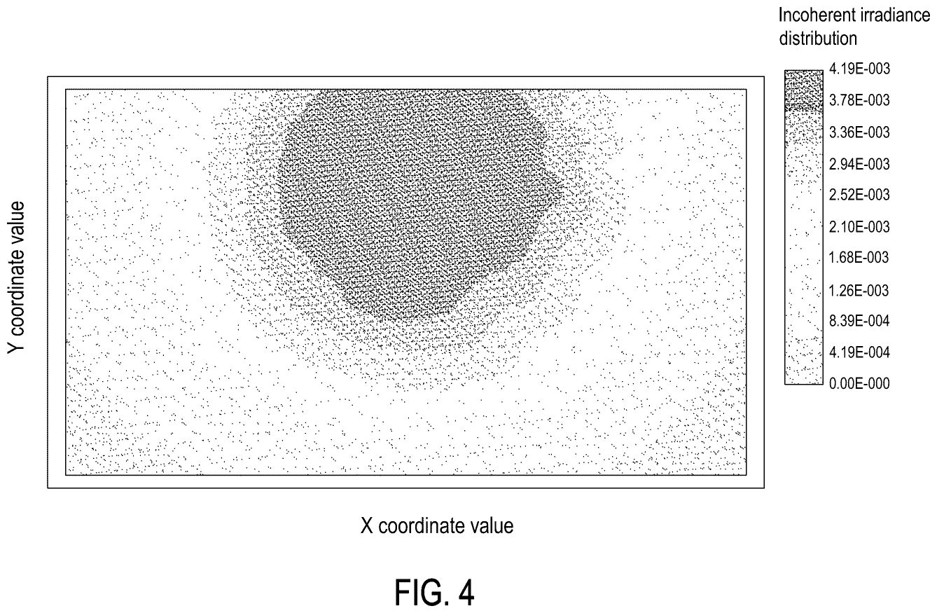

FIG. 4 is an irradiance distribution diagram of the projection device according to an embodiment of the disclosure. Referring to FIG. 4, it can be found with an optical simulation system (e.g., Zemax) that the projection device 1 of this embodiment has good performance in terms of each of geometric efficiency on the projection screen, image central irradiance, and irradiance uniformity. The peak irradiance can reach 4.19*10⁻³ watts per square centimeter (W/cm²), and the total power of the image picture can reach 5.58*10¹ watts (W). Compared to the peak irradiance and the total power respectively being 2.83*10⁻³ watts per square centimeter (W/cm²) and 3.44*10¹ watts (W) in the conventional art, the projection device 1 of this embodiment has good performance in terms of each of picture central irradiance and irradiance uniformity.

In summary of the above, in the projection device provided according to the embodiments of the disclosure, the Fresnel lens element is arranged between the light source and the display panel. After exiting the display panel, the optical path of the image beam does not further pass through a Fresnel lens element, so it is possible to avoid reduction in the quality of the image caused by a Fresnel lens element. In addition, the freeform-surface reflective mirror can increase the design freedom. The lens elements inside the projection lens do not need to be arranged in an offset configuration, and the volume size can be maintained. Accordingly, the optical structure and design can be simplified, the product cost can be reduced, and good resolution ability can be maintained without causing various distortions.

The foregoing description of the exemplary embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the invention”, “the disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. A projection device comprising:
a light source module configured to provide an illumination beam and comprising a light source, a first Fresnel lens element, and a second Fresnel lens element, wherein the first Fresnel lens element and the second Fresnel lens element respectively have a first light incident surface and a second light incident surface, a normal of the first light incident surface is parallel to a normal of the second light incident surface, and the first Fresnel lens element is arranged between the light source and the second Fresnel lens element;
a display panel configured to convert the illumination beam into an image beam, wherein the first Fresnel lens element and the second Fresnel lens element are arranged between the light source and the display panel;
a freeform-surface reflective mirror arranged on a path of the image beam, wherein the display panel is arranged between the light source module and the freeform-surface reflective mirror; and
a projection lens configured to transmit the image beam from the freeform-surface reflective mirror out of the projection device, wherein the projection lens comprises a lens optical axis, and a direction of the lens optical axis is different from a direction of the normal of the first light incident surface.

2. The projection device according to claim 1, wherein the first Fresnel lens element and the second Fresnel lens element respectively have a first optical axis and a second optical axis, and the first optical axis overlaps with the second optical axis.

3. The projection device according to claim 2, wherein an optical axis of the light source overlaps with the second optical axis.

4. The projection device according to claim 1, wherein the display panel has a display surface, an angle is present between the first light incident surface and the display surface, and the angle is greater than or equal to 2 degrees and less than or equal to 10 degrees.

5. The projection device according to claim 1, wherein the image beam is directly irradiated to the freeform-surface reflective mirror after exiting the display panel.

6. The projection device according to claim 1, wherein the light source module further comprises a condensing element arranged between the first Fresnel lens element and the light source.

7. The projection device according to claim 1, wherein a focal length of the first Fresnel lens element is less than a focal length of the second Fresnel lens element.

8. The projection device according to claim 1, wherein the light source module further comprises a polarizing element arranged between the first Fresnel lens element and the second Fresnel lens element or between the second Fresnel lens element and the display panel, wherein the polarizing element is parallel to the second Fresnel lens element.

9. The projection device according to claim 8, wherein the polarizing element comprises a reflective polarizer and a linear polarizer.

10. The projection device according to claim 1, wherein orthogonal projection areas of the first Fresnel lens element and the second Fresnel lens element onto the display panel are the same as each other.
